(19) United States
(12) Patent Application Publication
(10) Pub. No.: US 2013/0005047 A1
(43) Pub. Date: Jan. 3, 2013

(54) LUMINESCENCE LIFETIME BASED ANALYTE SENSING INSTRUMENTS AND CALIBRATION TECHNIQUE

(75) Inventors: Daniel W. Mayer, Wyoming, MN (US); Michael D. Howe, Blaine, MN (US); Timothy A. Ascheman, Elk River, MN (US); John Eastman, Rogers, MN (US)

(73) Assignee: MOCON, INC., Minneapolis, MN (US)

(21) Appl. No.: 13/581,818

(22) PCT Filed: Mar. 10, 2011
(86) PCT No.: PCT/US11/27878

§ 371 Date: Aug. 30, 2012

Related U.S. Application Data
(60) Provisional application No. 61/317,509, filed on Mar. 25, 2010.

(51) Int. Cl. G01N 21/64; G01D 18/00

(52) U.S. Cl. 436/138; 73/1.01

(57) ABSTRACT

A method of calibrating a luminescence lifetime sensing instrument 20 and of interrogating a target-analyte long-decay luminescence probe 120 includes measuring and reporting luminescence lifetime of the probe 120 employing excitation radiation filtered to remove emission radiation, or a starting time tstart delayed by a predetermined decay delay time, or delayed by a predetermined growth delay time, or an ending time comprising the time at which luminescence intensity has decayed or risen a predetermined percentage.

This application claims the benefit of U.S. Provisional Application No. 61/317,509, filed Mar. 25, 2010

### BACKGROUND

Solid-state polymeric materials based on target-analyte-sensitive photoluminescent dyes are widely used as optical target-analyte sensors and probes. See, for example United States Published Patent Applications 2009/0029402, 2008/8242870, 2008/215254, 2008/199360, 2008/190172, 2008/148817, 2008/146460, 2008/117418, 2008/0051646, and 2006/0002822, and U.S. Pat. Nos. 7,569,395, 7,534,615, 7,368,153, 7,138,270, 6,689,438, 5,718,842, 4,810,655, and 4,476,870. Such optical sensors are available from a number of suppliers, including Presens Precision Sensing, GmbH of Regensburg, Germany, Oxysense of Dallas, Tex., United States, and Luxcel Biosciences, Ltd of Cork, Ireland.

Target-analyte partial pressure of a fluid system can be ascertained by placing a target-analyte quenchable luminescent probe into fluid communication with the system of interest (e.g., the enclosed retention chamber of a Petri dish, the interior of modified atmosphere packaged foodstuffs, or the headspace of a bottled beverage) and interrogating luminescence characteristics of that probe with a sensing instrument. See, for example United States Published Patent Application 2009/0028756.

Typical sensing instruments expose the probe to excitation radiation over time, measure radiation emitted by the excited probe over time and convert at least some of the measured emissions to a target-analyte concentration based upon a known conversion algorithm.

Radiation emitted by the excited probe can be measured in terms of intensity and/or lifetime (rate of decay, phase shift or anisotropy), with measurement of lifetime generally preferred as a more accurate and reliable measurement technique when seeking to establish a concentration of target-analyte by measuring the extent to which a luminescent dye has been quenched by the target-analyte.

Sensing instruments that measure radiation emitted by an excited probe in terms of luminescence lifetime must be calibrated, which is typically achieved by empirically generating a Stern-Volmer plot from a plurality of luminescence lifetime data points obtained by interrogating a target-analyte quenchable probe exposed to a different known concentration of target-analyte with the instrument being calibrated, and employing the slope of the generated Stern-Volmer plot to calibrate the instrument.

### The Stern-Volmer Equation

Atoms and molecules can be excited by the absorption of a photon. Such excited particles can return to a ground state by a number of routes. One route is the radiative emission of a photon of light, producing luminescence. Alternatively, such particles return to ground by non-radiative means such as collisions with other atoms or molecules (known as dynamic quenching) or traveling along a down-hill energy path that involves multiple coupled vibrational and electronic energy states.

In a system containing strongly luminescent molecules A, a temporary concentration of excited state molecules [A*] can be generated by exposing the system to radiant energy of the proper wavelength. If there are no quenching agents present in the system (i.e., there are no species present in the system that can quench luminescence through bimolecular collisions), then A* can return to the ground state by luminescence

A* [symbol] A+hv (1)

and by non-radiative decay

A* [symbol] A (2)

where k₁ and k₂ are the rate constants for these two processes.

With only these two paths to ground state available, the rate equation for [A*] can be written as

d[A*]/dt=−k₁[A*]−k₂[A*]=−(k₁+k₂)[A*] (3)

Rearrangement and integration of equation (3) with respect to initial conditions: t=0 and [A*]=[A*]₀ gives

[A*]=[A*]₀e^{-(k1+k2)t} (4)

According to this result, the concentration of excited species [A*] (and therefore luminescence) is expected to decay in an exponential fashion, with the rate constants k₁ and k₂ quantifying the rate of such decay.

For convenience, we will define a ‘fluorescence lifetime in the absence of quencher’ (τ₀) as:

τ₀=1/(k₁+k₂) (5)

where τ₀ is the amount of time that it takes for the luminescence intensity to decay to 1/e or 36.8% its initial value.

If a quenching agent (q) is present in solution, then a third path becomes available for returning A* molecules to the ground state;

A*+Q [symbol] A (6)

and the rate equation for [A*] becomes

d[A*]/dt=−(k₁+k₂+k_{q}[Q])[A*] (7)

Where k_{q} is the quenching constant.

Assuming [Q] is much greater than [A*], [Q] can be treated as a constant, allowing equation (7) to be integrated to give

[A*]=[A*]₀e^{-(k1+k2+kq[Q])t} (8)

with ‘luminescence lifetime in the presence of quencher’ (τ) defined as:

τ=1/(k₁+k₂+k_{q}[Q]) (9)

To isolate the effects of quenching, luminescence lifetime measurements are carried out over a range of known quenching agent concentrations (including [Q]=0). A luminescence decay curve is recorded for each trial and each decay curve is fit to an exponential function, yielding a lifetime for each trial.

Dividing equation (9) into equation (5) gives

τ₀/τ=(k₁+k₂+k_{q}[Q])/(k₁+k₂)

or, upon simplification

τ₀/τ=1+k_{q}τ₀[Q] (10)

According to equation (10), a plot of τ₀/τ versus [Q] should be linear with an intercept equal to one, and a slope equal to k_{q}τ₀, thereby permitting the quenching rate constant k_{q} to be ascertained. Such a plot is known as a Stern-Volmer plot with k_{q} comprising the calibration constant for each instrument used to measure luminescence lifetime of an excited probe.

Current systems and techniques for generating Stern-Volmer plots used to calibrate optical instruments are subject to various vagaries that produce nonlinear Stern-Volmer plots, significantly complicating calibration efforts and typically producing calibration error.

Accordingly, a substantial need exists for a system and technique of generating accurate linear or substantially linear Stern-Volmer plots for use in calibrating instruments that measure radiation emitted by an excited probe in terms of luminescence lifetime.

### SUMMARY OF THE INVENTION

A first aspect of the invention is a method of calibrating an instrument effective for optically interrogating a luminescence target-analyte probe capable of emitting radiation at a first wavelength when exposed to excitation radiation, and determining target-analyte partial pressure from a luminescence lifetime measurement obtained from the probe.

A first embodiment of the first aspect of the invention includes the steps of (i) empirically generating a Stern-Volmer plot from a plurality of luminescence lifetime data points obtained by interrogating a target-analyte quenchable probe exposed at different known concentrations of target-analyte with excitation energy generated by an excitation energy source onboard the instrument is filtered to remove radiation at the first wavelength from the excitation energy prior to transmission of the excitation energy onto the probe, and (ii) calibrating the instrument from the generated Stern-Volmer plot.

A second embodiment of the first aspect of the invention includes the steps of (i) empirically generating a Stern-Volmer plot from a plurality of luminescence lifetime data points obtained by interrogating a target-analyte quenchable probe exposed at different known concentrations of target-analyte, with each luminescence lifetime comprising a time period measured from a starting time comprising a time at which an excitation energy source onboard the instrument is shut-off—delayed by a predetermined decay delay time, until an ending time comprising a time at which the luminescence intensity at the starting time has decayed a predetermined percentage, and (ii) calibrating the instrument from the generated Stern-Volmer plot.

A third embodiment of the first aspect of the invention includes the steps of (i) empirically generating a Stern-Volmer plot from a plurality of luminescence lifetime data points obtained by interrogating a target-analyte quenchable probe exposed at different known concentrations of target-analyte, with each luminescence lifetime comprising a time period measured from a starting time to an ending time, wherein the ending time comprises a time at which a luminescence intensity at the starting time has decayed a predetermined percentage of between 30% and 60%, and calibrating the instrument from the generated Stern-Volmer plot.

A second aspect of the invention is a method of optically interrogating a target-analyte probe effective for emitting luminescent radiation at a first wavelength when exposed to excitation radiation at a second wavelength.

A first embodiment of the second aspect of the invention includes the steps of (i) exposing the probe to excitation radiation from which radiation at the first wavelength has been filtered, to generate an excited probe, (ii) measuring the intensity of radiation emitted by the excited probe after such exposure, and (iii) measuring and reporting luminescence lifetime of the probe comprising that time period measured from a starting time comprising a time at which the luminescence intensity of emitted radiation is proximate a maximum value until an ending time comprising a time at which the luminescence intensity of emitted radiation has decayed a predetermined percentage from the luminescence intensity at the starting time. Such measured and reported luminescence lifetime is indicative of target-analyte partial pressure in fluid communication with the probe.

A second embodiment of the second aspect of the invention includes the steps of (i) exposing the probe to excitation radiation from an excitation energy source, to generate an excited probe, (ii) measuring the intensity of radiation emitted by the excited probe after the exposure, and (iii) measuring and reporting luminescence lifetime of the probe comprising that time period measured from a starting time comprising a time at which the excitation energy source is shut-off—delayed by a predetermined decay delay time, until an ending time comprising a time at which the luminescence intensity of emitted radiation has decayed a predetermined percentage from the luminescence intensity at the starting time. Such measured and reported luminescence lifetime is indicative of target-analyte partial pressure in fluid communication with the probe.

A third embodiment of the second aspect of the invention includes the steps of (i) exposing the probe to excitation radiation from an excitation energy source, to generate an excited probe, (ii) measuring the intensity of radiation emitted by the excited probe after the exposure, and (iii) measuring and reporting luminescence lifetime of the probe comprising that time period measured from a starting time to an ending time, wherein the starting time comprises a time at or after maximum luminescence intensity, and the ending time comprises a time at which the luminescence intensity at the starting time has decayed a predetermined percentage of between 30% and 60%. Such measured and reported luminescence lifetime is indicative of target-analyte partial pressure in fluid communication with the probe.

A fourth embodiment of the second aspect of the invention includes the steps of (i) exposing the probe to excitation radiation from an excitation energy source, to generate an excited probe, (ii) measuring the intensity of radiation emitted by the excited probe after the exposure, and (iii) measuring and reporting luminescence lifetime of the probe comprising a time period measured from a starting time comprising that time at which the excitation energy source is turned-on—delayed by a predetermined rise delay time, until an ending time comprising a time at which the luminescence intensity of emitted radiation has risen a predetermined percentage from the luminescence intensity at the starting time. Such measured and reported luminescence lifetime is indicative of target-analyte partial pressure in fluid communication with the probe.

A fifth embodiment of the second aspect of the invention includes the steps of (i) exposing the probe to excitation radiation from an excitation energy source, to generate an excited probe capable of emitting a peak luminescence intensity, (ii) measuring the intensity of radiation emitted by the excited probe after the exposure, and (iii) measuring and reporting luminescence lifetime of the probe comprising that time period measured from a starting time to an ending time, wherein the starting time comprises a time at or after minimum luminescence intensity, and the ending time comprises a time at which luminescence intensity has risen to a predetermined percentage of between 30% and 60% of peak luminescence intensity. Such measured and reported luminescence lifetime is indicative of target-analyte partial pressure in fluid communication with the probe.

### BRIEF DESCRIPTION OF THE DRAWINGS

FIG. 1 is a cross-sectional side view of one embodiment of an instrument for optically interrogating a luminescence target-analyte probe.

FIG. 2 is a diagram of one embodiment of an electrical analog subsystem for the instrument depicted in FIG. 1.

FIG. 3 is an exemplary Stern-Volmer Plot of luminescence lifetime ratios (τ₀/τ) versus concentration of oxygen [Q] or % O₂.

FIG. 4 is an exemplary luminescence growth and decay curve with overlaid inverted curve generated by an inverting amplifier.

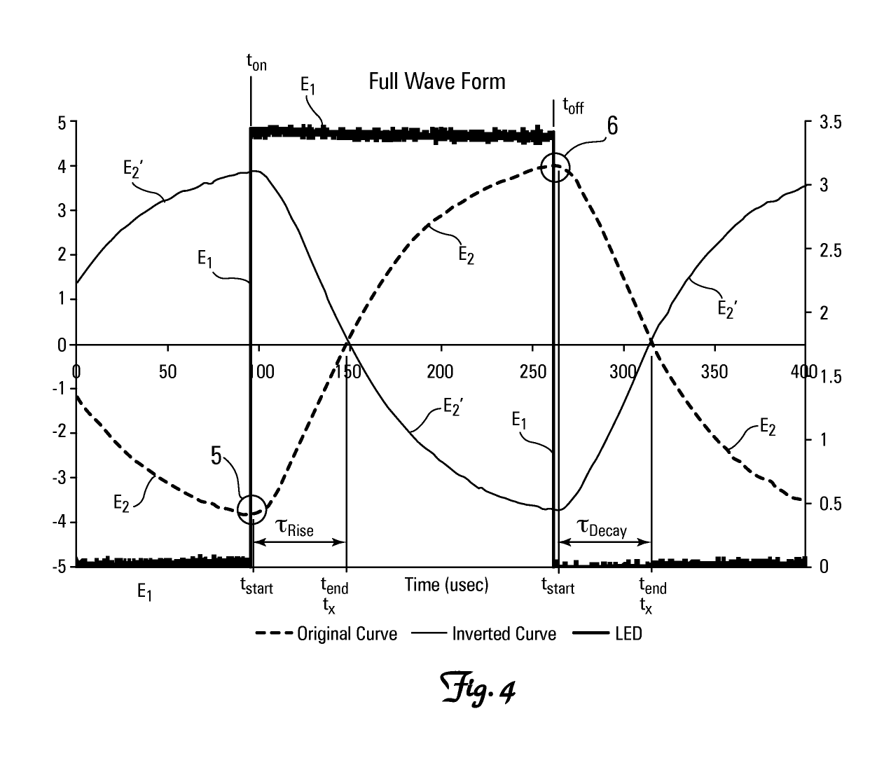

FIG. 5 is a grossly enlarged view of that portion of the luminescence growth and decay curve of FIG. 4 at which growth commences.

FIG. 6 is a grossly enlarged view of that portion of the luminescence growth and decay curve of FIG. 4 at which the curve transitions from growth to decay.

### DETAILED DESCRIPTION OF A PREFERRED EMBODIMENT

### Definitions

As used herein, including the claims, the phrase “decay delay” means the period of time it takes for the intensity of luminescence emitted by a probe to commence natural logarithmic rate of decay after the excitation energy source has been shut off.

As used herein, including the claims, the phrase “rise delay” means the period of time it takes for the intensity of luminescence emitted by a probe to commence exponential rise after the excitation energy source has been turned on.

As used herein, including the claims, the phrase “target analyte” means a molecule whose presence-absence is detected and measured. Typical target-analytes are oxygen O₂ and carbon dioxide CO₂.

As used herein, including the claims, the phrase “essentially 100%” means containing only trace amounts of contaminants.

### NOMENCLATURE

10 Optical Target-Analyte Sensing System
20 Detection Instrument
30 Optics Components of Detection Instrument
31 Source of Excitation Radiation or Light Emitting Diode (LED)
32 Band Pass Filter Passing Excitation Wavelength Radiation
33 Beam Splitter Reflecting Excitation Wavelength Radiation
34 Lens
35 Band-Pass Filter Passing Emitted Wavelength Radiation
36 Photodiode
39 Primary Channel in Detection Instrument
40 Electrical Signal Processing System of Detection Instrument
41 First AC Coupling
42 Preamplifier
43 Automatic Gain Control (AGC)
44 Second AC Coupling
45 Gain Amplifier
46 Inverting Amplifier
47 Comparator
48 Accumulator
49 Analog to Digital Converter (A/D)
50 Microprocessor
61 IR Probe Temperature Sensor
62 Ambient Temperature Sensor
63 Ambient Pressure Sensor
64 Lifetime Count Delay Circuit 120 Probe
E₁ Excitation Radiant Energy from Detection Instrument
E₂ Emitted Radiant Energy from Probe
E₂′ Inverted Curve of Emitted Radiant Energy from Probe
tₛₜₐᵣₜ Starting Time
t_{End} Ending Time
t_{On} Time at which Excitation Energy Source is Turned On
t_{Off} Time at which Excitation Energy Source is Turned Off
tₓ Time at which Primary Signal and Inverted Signal are Equal
Δt_{DeCay Delay} Time Lapse Between t_{Off} and t_{Start}
Δt_{Rise Delay} Time Lapse Between t_{Off} and t_{Start}
τ_{Rise} Rise or Growth Luminescence Lifetime
τ_{Decay} Fall or Decay Luminescence Lifetime

### Description

Construction

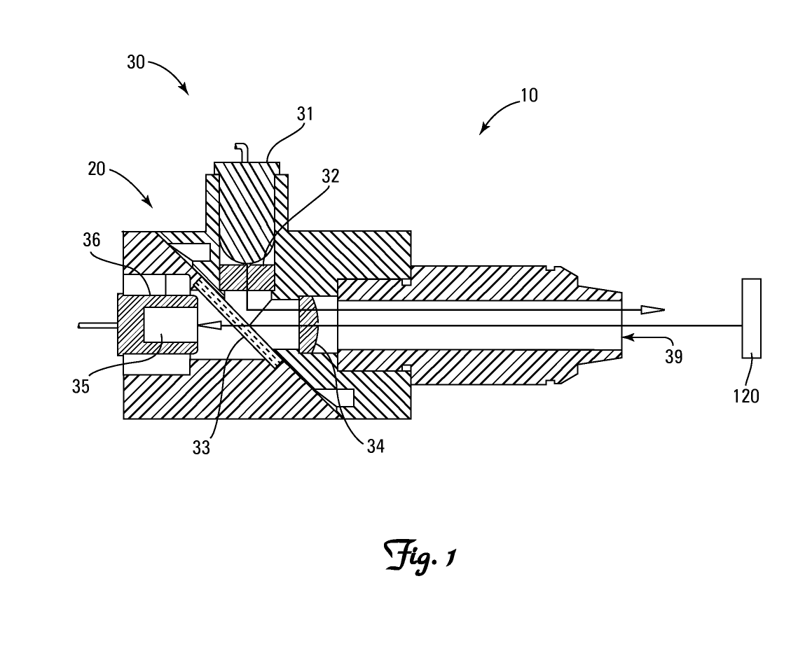

The invention involves calibration and use of an optical target-analyte sensing system 10. An embodiment of such an optical target-analyte sensing system 10 is depicted in FIG. 1. The system 10 depicted in FIG. 1 includes a detection instrument 20 and a probe 120.

For purposes of simplicity only, and without intending to be limited thereto, the balance of the description may default to oxygen O₂ as the target-analyte since O₂-sensitive probes 120 are the most commonly used types of optically active probes 120.

### Detection Instrument

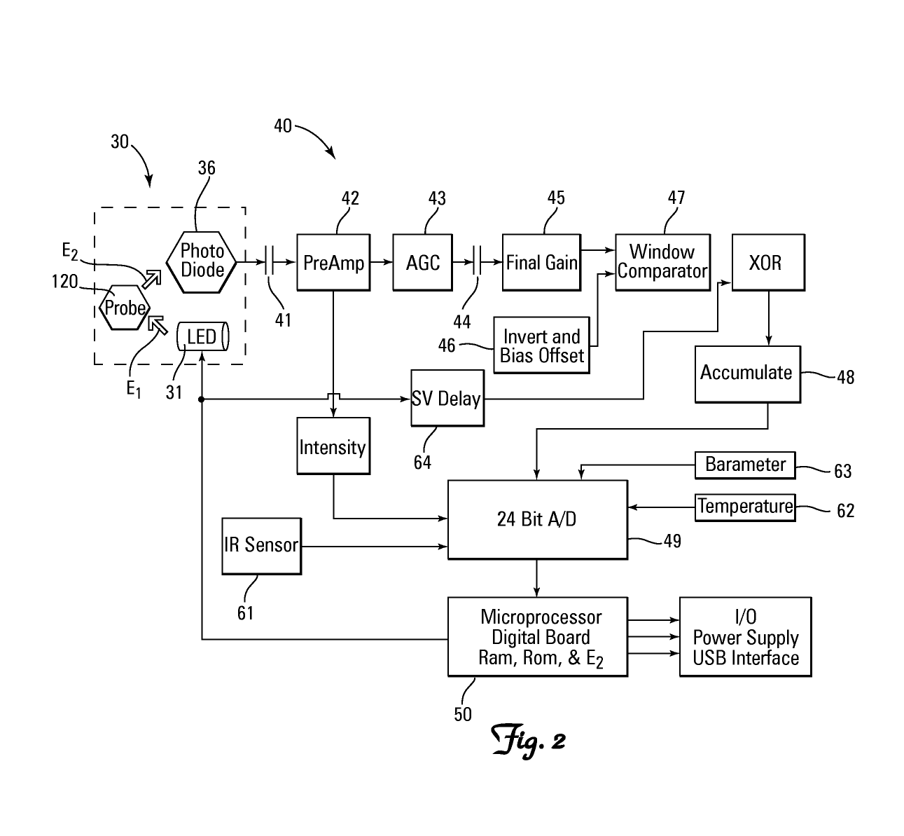

The detection instrument 20 is configured and arranged to optically interrogate a target-analyte-sensitive probe 120 by generating and directing excitation energy E₁ having a first wavelength onto the probe 120, followed by detection and measurement of the intensity of radiant energy E₂ having a second wavelength different form the first wavelength emitted by the excited probe 120 over time (t). For purposes of discussion, the detection instrument 20 is separated as between the optical components 30 shown in FIG. 1 and the electrical components 40 shown in FIG. 2.

Referring to FIG. 1, the optics components 30 of the detection instrument 20 include a source of excitation energy 31, such as a light emitting diode (LED). The source of excitation energy 31 is selected to generate excitation energy E₁ at wavelengths effective for exciting a selected probe 120. For example, an oxygen sensitive platinum(II)-octaethylporphine-ketone (PtOEPK) probe 120 is excited by radiant energy having a wavelength of 390 nm.

A beam splitter 33 reflects the excitation energy E₁ generated by the source of excitation energy 31 down a primary channel 39 and out through a distal end (unnumbered) of the instrument 20.

An optical filter 32 is provided between the source of excitation energy 31 and the primary channel 39 for blocking or attenuating radiant energy generated by the source of excitation energy 31 having a wavelength that matches the wavelength of the radiant energy E₂ emitted by a probe 120 to be interrogated by the instrument 20.

A probe 120 contacted by a focused beam of excitation energy E₁ emanating from the instrument 20 will luminesce and emit radiant energy E₂ having a wavelength that is different from the wavelength of the excitation energy E₁. For example, an oxygen sensitive platinum(II)-octaethylporphine-ketone (PtOEPK) probe 120 is excited by radiant energy E₁ at a wavelength of 590 nm and emits radiant energy E₂ at a wavelength of 760 nm, and an oxygen sensitive platinum(II)-tetrakis(pentafluorophenyl)porphine (PtPFPP) probe 120 is excited by radiant energy E₁ at wavelengths of both 525 and 400 nm and emits radiant energy E₂ at a wavelength of 650 nm. Emitted energy E₂ generated by the excited probe 120 will travel up the primary channel 39, unabated through the beam splitter 33, and into contact with a photodiode 36 capable of sensing the intensity of the emitted energy E₂ over time and generating an electrical signal representative of the intensity of the emitted energy E₂ reaching the photodiode 36.

A lens 34 is preferably provided in the primary channel 39 for focusing the emitted radiant energy E₂ traveling up the primary channel 39 onto a small sensing area on the photodiode 36. This allows use of a photodiode 36 with a small sensing area (not shown) without loss of signal level. A smaller sensing area requires less capacitance, thereby making a larger bandwidth available—resulting in more accurate lifetime luminescence decay curves.

The photodiode 36 may be selected from any of the wide variety of photodiodes 36 including, but not limited to UV enhanced, high speed epitaxail, low dark current, low capacitance, quadrant and black photodiodes, as well as avalanche types such as high speed, IR enhanced, blue enhanced and Geiger. The photodiode 36 of choice is a low capacitance, high speed photodiode with the largest possible area within the limits of practicality.

To prevent stray radiant energy from reaching the photodiode 36 and contaminating the electrical signal, an optical filter 35 is provided between the beam splitter 33 and the photodiode 36 for blocking or attenuating radiant energy with wavelengths other than the wavelength of the radiant energy E₂ emitted by a probe 120 interrogated by the instrument 20.

Referring to FIG. 2, the optical components 30 interface with the electrical components 40 at the photodiode 36, which is capacitively coupled to a preamplifier 42 through an A/C coupling 41 to reduce ambient light and temperature effects. The preamplifier 42 is preferably a polyphenylene sulfide (PPS) capacitor to reduce ambient temperature effects even further.

The preamplifier 42 is preferably a high speed (e.g., at least 100 MHz) operational amplifier with a gain of 100K-150K. The preamplifier 42 can feed directly into another preferably high speed operational amplifier 45 with a gain of about 100 for purposes of maintaining a bandwidth of about 10 MHz.

The signal from the preamplifier 42 can be split to allow both intensity and lifetime measurements to be made. The intensity measurement can be of interest in some applications, and can also be used to make small corrections or adjustments to the lifetime measurement. One of the split signals from the preamplifier 42 is communicated to an automatic gain control (AGC) 43 to normalize the amplitude of the signal and provide downstream components with a fixed range or gain. The signal is AC coupled 44 to reduce bias, inverted 46 to produce an inverted curve E₂′ of emitted radiant energy to center the signal around zero and analyzed in a comparator 47 for ascertaining the time tₓ at which the primary signal curve and the inverted signal curve cross. This allows LED shut off t_{Off} to be used as the starting time tstart for measuring decay luminescence lifetime τ_{Decay} and allows a 50% loss of luminescence to be used as the ending time t_{End} for measuring decay luminescence lifetime τ_{Decay} as the circuitry can detect a 50% loss of luminescence as this is the point in time tₓ at which the primary signal curve and the inverted signal curve cross. Employing these points as the starting time t_{Start} and ending time t_{End} for measuring decay luminescence lifetime τ_{Decay} produces a more accurate measurement of decay luminescence lifetime τ_{Decay} as it provides a rapid, reliable and consistent starting and stopping point that avoids the need to detect luminescence and calculate % luminescence loss after a loss of greater than 60% luminescence—which is a time period fraught with excessive fluctuations in the luminescence signal.

Since the rate of luminescence rise is a mirror image of the rate at which luminescence decays—as least for the initial 50% of rise and decay—the electronic signal processing circuitry 40 also allows LED turn on t_{On} to be used as the starting time t_{Start} for measuring growth luminescence lifetime τ_{Rise} and allows a 50% gain of luminescence to be used as the ending time t_{End} for measuring growth luminescence lifetime τ_{Rise} as the circuitry can detect a 50% rise of luminescence as this is the point in time tₓ at which the primary signal curve and the inverted signal curve cross. Employing these points as the starting time t_{Start} and ending time t_{End} for measuring growth luminescence lifetime τ_{Rise} produces a more accurate measurement of growth luminescence lifetime τ_{Rise} as it provides a rapid, reliable and consistent starting and stopping point along the growth portion of the luminescence lifetime curve that truthfully mimics the corresponding decay portion of the luminescence lifetime curve.

Electronic signals indicative of the values of measured decay luminescence lifetimes τ_{Decay} and/or growth luminescence lifetimes τ_{Rise} are counted and accumulated 48 before being sent to an A/D converter 49 and a microprocessor 50 for processing.

The electrical signal processing system 40 allows construction of a portable low cost detection instrument 20 as it permits rapid and accurate measurement of decay luminescence lifetime τ_{Decay} with a low speed A/D converter 49 and microprocessor 50 and requires limited power. It also allows the instrument 20 to communicate via a USB port (not shown).

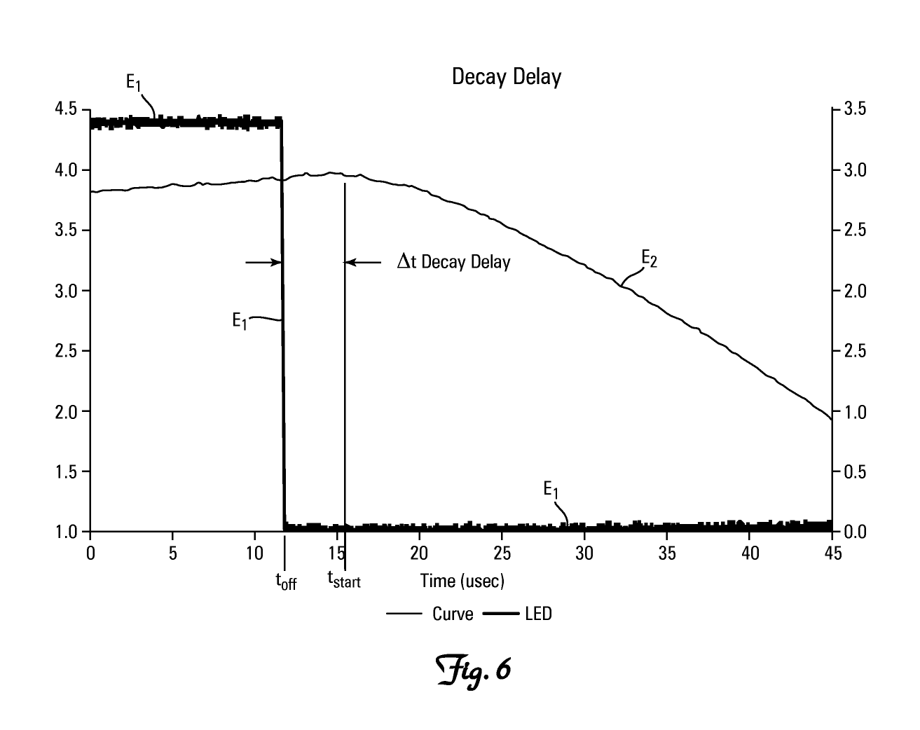

Referring to FIG. 6, it has been discovered that exponential decay as predicted by the Stern-Volmer relationship does not commence immediately at t_{Off}. In order to accurately measure τ_{Decay} the electronic signal processing system 40 includes a delay timer 64 for providing a short delay Δt_{Decay Delay} of about 0.5 and 6 μsec, preferably about 0.5 and 2 μsec, after t_{Off} before commencing measurement of τ_{Decay}.

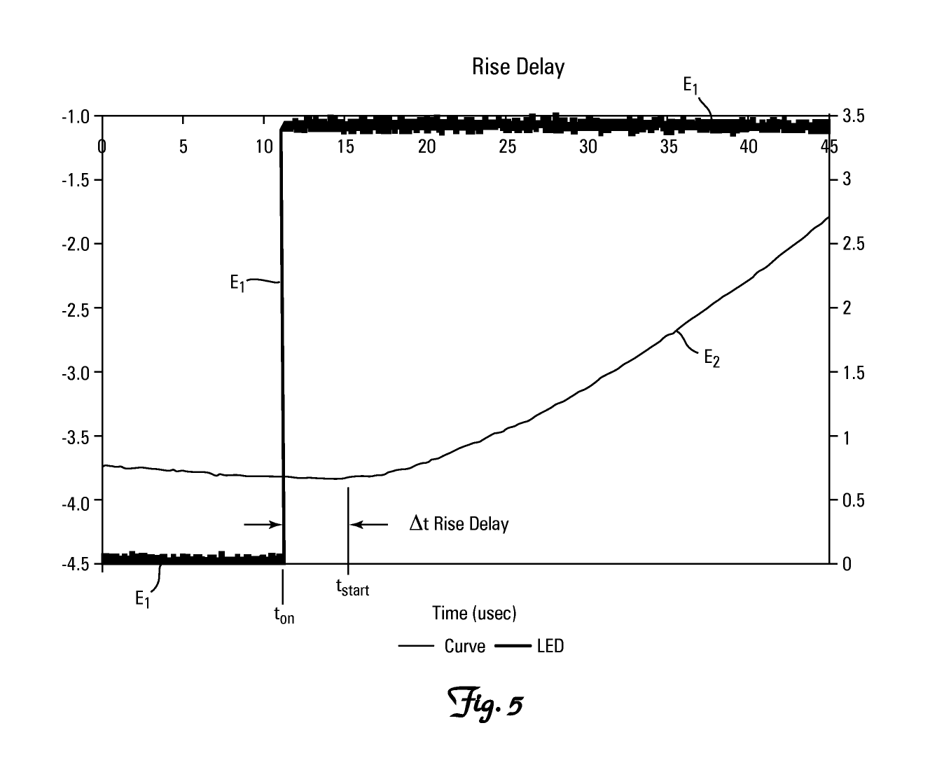

Referring to FIG. 5, this same phenomena has been observed in connection with luminescence growth at t_{On}. As with τ_{Decay}, in order to accurately measure τ_{Rise} the electronic signal processing system 40 includes a delay timer 64 for providing a short delay Δt_{Rise Delay} of about 0.5 and 6 μsec, preferably about 0.5 and 2 μsec, after t_{On} before commencing measurement of τ_{Rise}.

Referring to FIG. 2, the electronic signal processing system 40 preferably also includes a first temperature sensor 61 for sensing the temperature of the probe 120, a second temperature sensor 62 for measuring the ambient temperature surrounding the detection instrument 20, and a barometer 63 for measuring ambient pressure surrounding the detection instrument 20 as each of these variables can affect reported results. Such compensatory adjustments are well known and understood by those skilled in art.

### Probe

The probe 120 is sensitive to the partial pressure of a target analyte (most commonly the partial pressure of oxygen) and therefore useful for optically ascertaining the partial pressure of oxygen (P_{O2}) within an enclosed space, such as the retention chamber of a hermetically sealed package (not shown). Such probes 120 include a thin film of a solid state photoluminescent composition (not independently shown) coated onto a support layer (not independently shown). The solid state photoluminescent composition includes an oxygen partial pressure sensitive (P_{O2} sensitive) photoluminescent dye (not independently shown) embedded within an oxygen permeable polymer matrix (not independently shown).

The oxygen-sensitive photoluminescent dye used in the solid state photoluminescent composition may be selected from any of the well-known P_{O2} sensitive photoluminescent dyes. One of routine skill in the art is capable of selecting a suitable dye based upon the intended use of the probe. A nonexhaustive list of suitable oxygen sensitive photoluminescent dyes includes specifically, but not exclusively, ruthenium(II)-bipyridyl and ruthenium(II)-diphenylphenanothroline complexes, porphyrin-ketones such as platinum(II)-octaethylporphine-ketone, platinum(II)-porphyrin such as platinum(II)-tetrakis(pentafluorophenyl)porphine, palladium(II)-porphyrin such as palladium(II)-tetrakis(pentafluorophenyl)porphine, phosphorescent metallocomplexes of tetrabenzoporphyrins, chlorins, azaporphyrins, and long-decay luminescent complexes of iridium(III) or osmium(II).

Typically, the oxygen-sensitive photoluminescent dye is compounded with a suitable oxygen-permeable hydrophobic carrier matrix. Again, one of routine skill in the art is capable of selecting a suitable oxygen-permeable hydrophobic carrier matrix based upon the intended use of the probe 120 and the selected dye. A nonexhaustive list of suitable polymers for use as an oxygen-permeable hydrophobic carrier matrix includes specifically, but not exclusively, polystyrene, polycarbonate, polysulfone, polyvinyl chloride and some co-polymers. The photoluminescent composition may be provided as a dispersed material, for example as aqueous suspension or powder of polymeric microparticles or nanoparticles impregnated with an oxygen-sensitive photoluminescent dye.

The support layer may be selected from any of the materials commonly employed as a support layer for a P_{O2} sensitive photoluminescent solid state composition. One of routine skill in the art is capable of selecting the material based upon the specific analyte to be detected and the intended use of the probe 120. A nonexhaustive list of substrates includes specifically, but not exclusively, cardboard, paperboard, polyester Mylar® film, non-woven spinlaid fibrous polyolefin fabrics, such as a spunbond polypropylene fabric.

The support layer is preferably between about 30 μm and 500 μm thick.

### EXAMPLES

### Example 1

### (Creation of Stern-Volmer Plot)

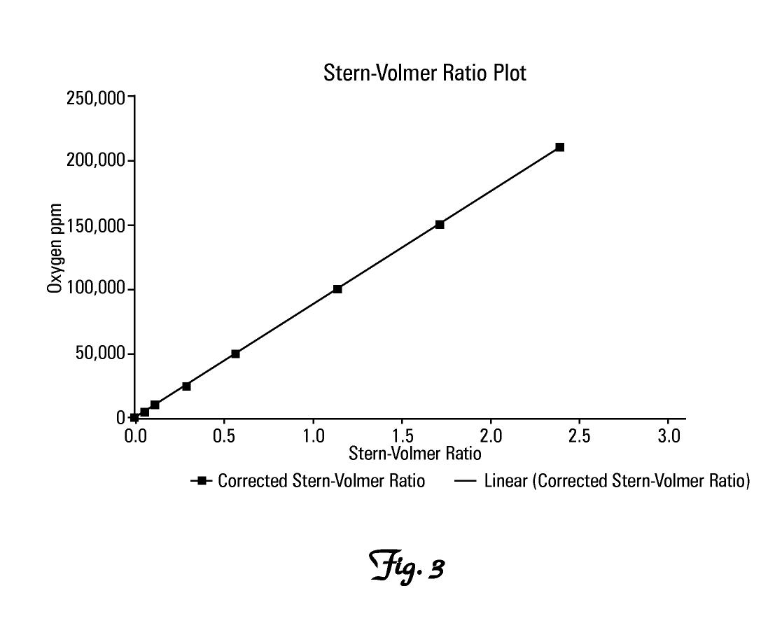

Luminescence lifetimes τ of a PtOEPK probe 120 exposed to known concentrations of O₂ as set forth in Table One, were ascertained by measuring and accumulating approximately 300 τ_{Rise} and τ_{Decay} employing the Δt_{Rise Delay}, Δt_{Decay Delay} and the % Luminescence at t_{End} as set forth in Table One. Three sets of accumulated values were averaged to obtain a raw measured τ time count set forth in Table One. The Δt_{Rise Delay} and Δt_{Decay Delay} set forth in Table One are added together and subtracted from each raw measured τ time count to obtain a corrected τ time count as set forth in Table One. A Stern-Volmer Ratio was calculated at each O₂ concentration by dividing the corrected τ time count obtained at an O₂ concentration of 0 (τ₀) by the corrected τ time count obtained at the given O₂ concentration (τ) and subtracting 1 from the obtained quotient. A Stern-Volmer plot of O₂ concentration v. Stern-Volmer Ratio is set forth in FIG. 3.

TABLE ONE

| | τ | | | | | |
|---|---|---|---|---|---|---|
| | Δt_{Rise Delay} | Δt_{Decav Delay} | % | Raw | Corrected | Stern- |
| Test Gas | Time Counts | Time Counts | Luminescence | Time Counts | Time Counts | Volmer |
| O₂ (ppm) | (300 reps) | (300 reps) | at t_{End} | (300 reps) | (300 reps) | Ratio |
| 0 | 640000 | 640000 | 50 | 14767454 | 13487454 | 0.00000 |
| 5035 | 640000 | 640000 | 50 | 14028973 | 12748973 | 0.05792 |
| 10000 | 640000 | 640000 | 50 | 13382944 | 12102944 | 0.11439 |
| 25000 | 640000 | 640000 | 50 | 11757379 | 10477379 | 0.28729 |
| 50000 | 640000 | 640000 | 50 | 9885062 | 8605062 | 0.56739 |
| 100000 | 640000 | 640000 | 50 | 7576857 | 6296857 | 1.14193 |
| 150000 | 640000 | 640000 | 50 | 6243572 | 4963572 | 1.71729 |
| 210000 | 640000 | 640000 | 50 | 5255515 | 3975515 | 2.39263 |

1. (canceled)

2. (canceled)

3. (canceled)

4. (canceled)

5. A method of calibrating an instrument effective for optically interrogating a luminescence target-analyte probe and determining target-analyte partial pressure from a luminescence lifetime measurement obtained from the probe, comprising the steps of:
(a) empirically generating a Stern-Volmer plot from a plurality of luminescence lifetime data points obtained by interrogating a target-analyte quenchable probe exposed at different known, concentrations of target-analyte, with each luminescence lifetime comprising a time period measured from a starting time to an ending time defined by a set of parameters selected from the group consisting of: (i) a starting time comprising a time at which an excitation energy source onboard the instrument is shut-off—delayed by a predetermined decay delay time, and an ending time comprising a time at which the luminescence intensity at the starting time has decayed a predetermined percentage, and (ii) an ending time comprising a time at which a luminescence intensity at the starting time has decayed a predetermined percentage of between 30% and 60%, and
(b) calibrating the instrument from the generated Stern-Volmer plot.

6. (canceled)

7. (canceled)

8. (canceled)

9. The method of claim S wherein the decay delay time is empirically derived with a value of between 0.5 and 6 μsec.

10. The method of claim 5 wherein the decay delay time Is iteratively determined with a value of between 0.5 and 2 μsec.

11. The method of claim 5 wherein the set of parameters is a starting time and an ending time and an ending time comprising a time at which a luminescence intensity at the starting time has decayed a predetermined percentage of between 30% and 60%.

12. (canceled)

13. (canceled)

14. (canceled)

15. The method of claim 11 wherein the predetermined percentage of luminescence decay is 50%.

16. The method of claim 11 wherein the ending time is the time at which a primary electrical signal generated by the instrument reflective of tumescence intensity is equal to a secondary electrical signal generated by an inverting amplifier receiving that same primary electrical signal.

17. A method of optically interrogating a target-analyte probe effective for emitting luminescent radiation at a first wavelength when exposed to excitation radiation at a second wavelength, comprising the steps of:
(a) exposing the probe to excitation radiation from an excitation energy source, to generate an excited probe capable of emitting a peak luminescence intensity.
(b) measuring intensity of radiation emitted by the excited probe after the exposure, and
(c) measuring and reporting luminescence lifetime of the probe comprising a time period measured from a starting time to an ending time defined by a set of parameters selected from the group consisting of: (i) a starting time comprising a time at which the luminescence intensity of emitted radiation is proximate a maximum value, an ending time comprising a time at which the luminescence intensity of emitted radiation has decayed a predetermined percentage from the luminescence intensity at the starting time, (ii) a starting time comprising a time at which the excitation energy source is shut-off, delayed by a predetermined decay delay time, and an ending time comprising a time at which the luminescence intensity of emitted radiation has decayed a predetermined percentage from the luminescence intensity at the starting time, (iii) a starting time comprising a time at or after maximum luminescence intensity, and an ending time comprising a time at which a luminescence intensity at the starting time has decayed a predetermined percentage of between 30% and 60%, (iv) a starting time comprising a time at which the excitation energy source is turned-on, delayed by a predetermined rise delay time, and an ending time comprising a time at which the luminescence intensity of emitted radiation has risen a predetermined percentage from the luminescence intensity at the starting time, and (v) a starting time comprising a time at or after minimum luminescence intensity, and an ending time comprising a time at which luminescence intensity has risen to a predetermined percentage of between 30% and 60% of peak luminescence intensity,
(d) whereby the reported luminescence lifetime is indicative of target-analyte partial pressure in fluid communication with the probe.

18. The method of claim 17 wherein the target-analyte is oxygen.

19. The method of claim 17 wherein the excitation energy source is a light emitting diode.

20. The method of claim 17 wherein the measured luminescence lifetime is compared to a predetermined threshold value and a perceptible signal is generated when the measured luminescence lifetime is less than the threshold value, indicating the probe is in fluid communication with an excessive partial pressure of target-analyte.

21. The method of claim 17 wherein the measured luminescence lifetime is compared to a predetermined threshold value and a perceptible signal is generated when the measured luminescence lifetime is greater than the threshold value, indicating the probe is in fluid communication with a deficient partial pressure of target-analyte.

22. The method of claim 17 wherein the set of parameters is a starting time comprising a time at which the excitation energy source is shut-off, delayed by a predetermined decay delay time, until an ending time comprising a lime at which the luminescence intensity of emitted radiation has decayed a predetermined percentage from the luminescence intensity at the starting time.

23. (canceled)

24. The method of claim. 22 wherein the decay delay time is empirically derived with a value of between 0.5 and 6 μsec.

25. The method of claim 22 wherein the decay delay time is iteratively determined with a value of between 0.5 and 2 μsec.

26. (canceled)

27. (canceled)

28. The method of claim 17 wherein the set of parameters is a starting time comprising a time at or after maximum luminescence intensity, and an ending time comprising a time at which a luminescence intensity at the starting time has decayed a predetermined percentage of between 30% and 60%.

29. (canceled)

30. (canceled)

31. (canceled)

32. The method of claim 28 wherein the predetermined percentage of luminescence decay is 50%.

33. The method of claim 28 wherein the ending time is the time at which a primary electrical signal generated by the instrument reflective of luminescence intensity is equal to a secondary electrical signal generated by an inverting amplifier receiving that same primary electrical signal.

34. The method of claim 17 wherein the set of parameters is a starting time comprising a time at which the excitation energy source is turned-on, delayed by a predetermined rise delay time, and an ending time comprising a time at which the luminescence intensity of emitted radiation has risen a predetermined percentage from the luminescence intensity at the starting time.

35. (canceled)

36. (canceled)

37. The method of claim 34 wherein the rise delay time is empirically derived with a value of between 0.5 and 6 μsec.

38. The method of claim 34 wherein the rise delay time is iteratively determined with a value of between 0.5 and 2 μsec.

39. (canceled)

40. (canceled)

41. The method of claim 17 wherein the set of parameters is a starting time comprising a time at or after minimum luminescence intensity, and an ending time comprising a time at which luminescence intensity has risen to a predetermined percentage of between 30% and 60% of peak luminescence intensity.

42. (canceled)

43. (canceled)

44. The method of claim 41 wherein the predetermined percentage of luminescence decay is 50%.

45. The method of claim 41 wherein the ending time is the time at which a primary electrical signal generated by the instrument reflective of luminescence intensity is equal to a secondary electrical signal generated fey an inverting amplifier receiving that same primary electrical signal.

46. The method of claim 17 wherein the set of parameters is a starting time comprising a time at which the luminescence intensity of emitted radiation is proximate a maximum value, and an ending time comprising a time at which the luminescence intensity of eon tied radiation has decayed a predetermined percentage from the luminescence intensity at the starting time.
